(19) United States
(12) Patent Application Publication
(10) Pub. No.: US 2005/0048821 A1
(43) Pub. Date: Mar. 3, 2005

(54) Clockspring flat cable termination

(76) Inventors: Patrick A. Bolen, Carthage, IL (US); Brent Henderson, Ursa, IL (US); Chris Wyatt, Hamilton, IL (US); Sean Bollin, Carthage, IL (US)

Correspondence Address: BLANK ROME LLP, 600 NEW HAMPSHIRE AVENUE, N.W., WASHINGTON, DC, 20037, US

(21) Appl. No.: 10/646,786

(22) Filed: Aug. 25, 2003

(51) Int. Cl. H01R 3/00

(52) U.S. Cl. 439/164

(57) ABSTRACT

The present invention is directed to a flat cable circuit board assembly having solder joints between the flat cable's round conductors and the solder pads of a circuit board, particularly in the clockspring of an automobile. The flat cable is formed without the use of adhesives by sonically bonding a top and bottom layer of insulating material around the round conductors. The end of the flat cable is stripped so that the round conductors can be soldered to the solder pads on the circuit board using a hot bar soldering process. The use of round conductors and solder pads on the circuit board allow for greater conductor density in the flat cable.

### FIELD OF INVENTION

The present invention relates to clocksprings used in automobiles, and in particular, the termination and the method of terminating a flat electrical cable having round conductors therein by soldering to a circuit board in a clockspring.

### BACKGROUND OF THE INVENTION

A majority of automobiles today utilize airbag crash systems. An airbag is typically located on the steering wheel facing the driver and must be in continuous electrical connection with sensors in the car body. The sensors provide an electrical signal to the airbag crash assembly which instantly inflates the airbag in the event of a crash. Clocksprings are found in virtually every vehicle to electrically connect rotating devices in the steering column to stationary components in other parts of the vehicle.

To facilitate the rotation of the clockspring, the electrical cable located within the housing of the clockspring is a flat cable which is wound around a central hub of the clockspring. The flat cable is terminated at a circuit board on the clockspring, for eventual connection to the airbag or other electrical device within the car. These connections are oftentimes made by welding the conductors in the flat cable to metal leads on the insert molded circuit board.

FIGS. 1a-1d show a current clockspring termination structure. FIG. 1a shows a bottom view of the exterior of a clockspring housing 10. The housing 10 includes two connection modules 12 and 14, each module having contacts 18 therein. The contacts 18 can be better seen in FIGS. 1b-1d. FIG. 1b shows a insert molded circuit board 16 which holds a total of ten (10) contacts 18 for both connection modules 12 and 14. The contacts 18 are connected to metal conductors 20 molded into the circuit board 16, which eventually form metal leads 22. FIGS. 1c and 1d show a top and perspective view, respectively, of a flat cable 24 with ten (10) flat conductors 26 welded to the metal leads 22, with each flat conductor 26 welded to a single metal lead 22.

The flat cable 24 is generally formed by sandwiching the flat conductors 26 between two insulating layers of plastic or similar material. The insulating layers in FIGS. 1c and 1b are transparent so that the flat conductors 26 can be seen. The insulating layers have an adhesive bonding agent on their interior sides which bond to each other and to the flat conductors 26. The ends of the flat cable 24 are stripped to expose the flat conductors 26 therein, which are then welded to the metal leads 22.

The welding structure of the prior art suffers from the disadvantage that it requires the metal leads to be spaced relatively far apart, resulting in larger clocksprings. The metal leads 22 are formed by a stamping process which requires that they be spaced a distance generally equal to the thickness of the metal leads 22 (in FIG. 1b, the thickness of the metal leads 22 is the height of the metal lead 22 going into and out of the page). This is necessary to prevent the metal leads 22 from deforming or jamming the stamping die during the stamping process.

A possible solution to this problem is to solder the flat conductors 26 directly to the insert molded circuit board 16. Soldering would remove the need for the metal leads 22, which would be replaced by solder pads that could be laid onto the insert molded circuit board 16 without the spacing demands of the metal leads 22. However, soldering flat conductors is not practiced because of the shortcoming of soldering a flat conductor to a flat surface. The interface between a flat conductor and a solder surface are not conducive to solder joints and provide a weak bond between the two surfaces.

Because of this drawback, most soldering is performed using round conductors. However, round conductors have not been used in flat cables because of the difficulty in removing the adhesive residue around the conductors. The presence of adhesive residue in solder joints weakens the joint, compromising its reliability and quality. Flat cables with flat conductors are typically stripped at the ends by grinding the insulating layers and adhesive off the flat conductors, which is effective in removing the majority of the adhesive residue. However, the grinding process cannot be used with round conductors because of the conductor's curvature. There is no way of accessing the adhesive at the round conductor's edges without grinding away portions of the conductor itself. Therefore, flat cables having round conductors have not been previously soldered to insert molded circuit boards.

More recently, a method of manufacturing flat cables without the use of adhesives has been disclosed in U.S. Pat. No. 6,026,563, issued to Tom Schilson (hereinafter referred to as “the '563 patent”) and assigned to Methode Electronics, Inc. of Chicago, Ill. The '563 patent is hereby incorporated in its entirety by reference. The '563 patent discloses a method of ultrasonically welding polyester layers around the conductors of a flat cable without using adhesives.

In view of the foregoing, it would be advantageous to provide a flat cable manufactured without the use of adhesives and having round conductors that may be soldered to an insert molded circuit board. It would be a further advantage to provide a high density flat cable having conductors that are spaced closely together and that are soldered to the solder pads of the insert molded circuit board to provide a flat cable with greater signal capacity.

### SUMMARY OF THE INVENTION

The present invention is directed towards a solder joint between a flat cable having round conductors and the solder pads of a circuit board in an automotive clockspring. The flat cable is formed by a top and bottom layer of insulating material which cover the round conductors. The insulating layers are bonded to one another using a sonic welding process, which allows the flat cable to be manufactured without the use of adhesives. The ends of the flat cable are stripped to expose the ends of the round conductors, which are then soldered to the solder pads on the insert molded circuit board using a hot bar soldering process.

### BRIEF DESCRIPTION OF THE DRAWINGS

FIG. 1a shows a bottom view of the exterior of a prior art clockspring housing;

FIG. 1b shows a circuit board used in a prior art clockspring;

FIGS. 1c and 1d show a flat cable welded to the circuit board of the prior art clockspring;

FIGS. 2a and 2b show a bottom view of the clockspring housing of the present invention, with and without a cable cover, respectively;

FIG. 2c shows a connection module located on the clockspring housing of the present invention;

FIGS. 3a-3c show a flat cable soldered to a circuit board of the clockspring of the present invention; and

FIG. 4 shows round conductors placed onto solder pads of a circuit board of the present invention;

FIG. 4a shows an end view of the round conductors along line 4-4 of FIG. 4; and

FIG. 5 shows the round conductors soldered to the solder pads of the circuit board of the present invention.

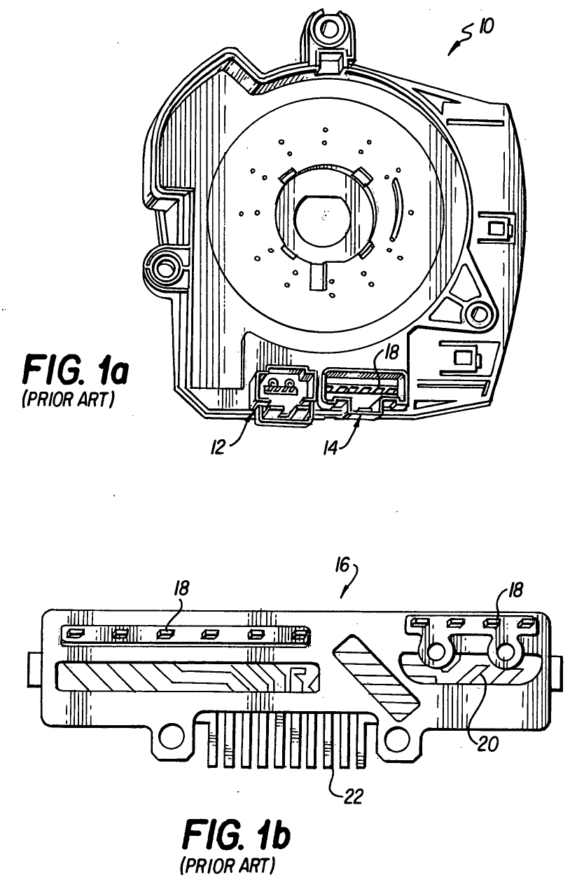

### DETAILED DESCRIPTION OF THE PREFERRED EMBODIMENT

Referring now to the several drawing figures in which identical elements are numbered identically throughout, a description of the preferred embodiment of the present invention will be provided.

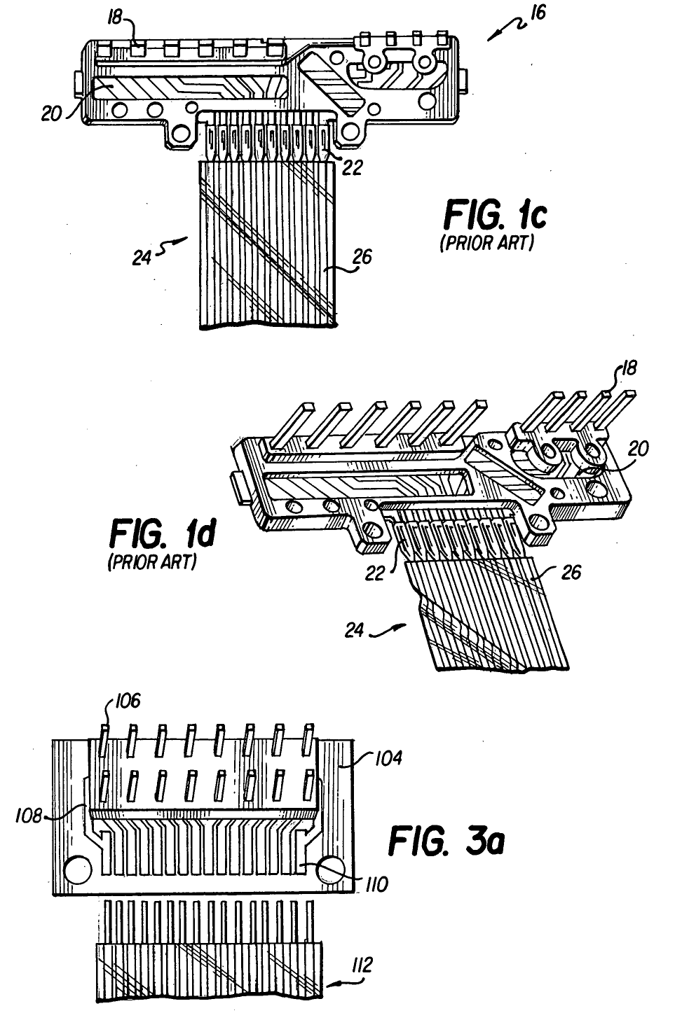

FIGS. 2a-2c shows a bottom view of the clockspring housing 100 of the present invention having a connection module 102 with sixteen (16) contacts 106 therein. FIG. 2a shows the housing 100 a cable cover 103 while FIG. 2b shows the cable cover 103 removed and a high density flat cable 112 lying therein. An end of the flat cable 112 is soldered to an insert molded circuit board 104 in the connection module 102, as explained later in greater detail. FIG. 2c shows an exploded view of the connection module 102 of FIG. 2b.

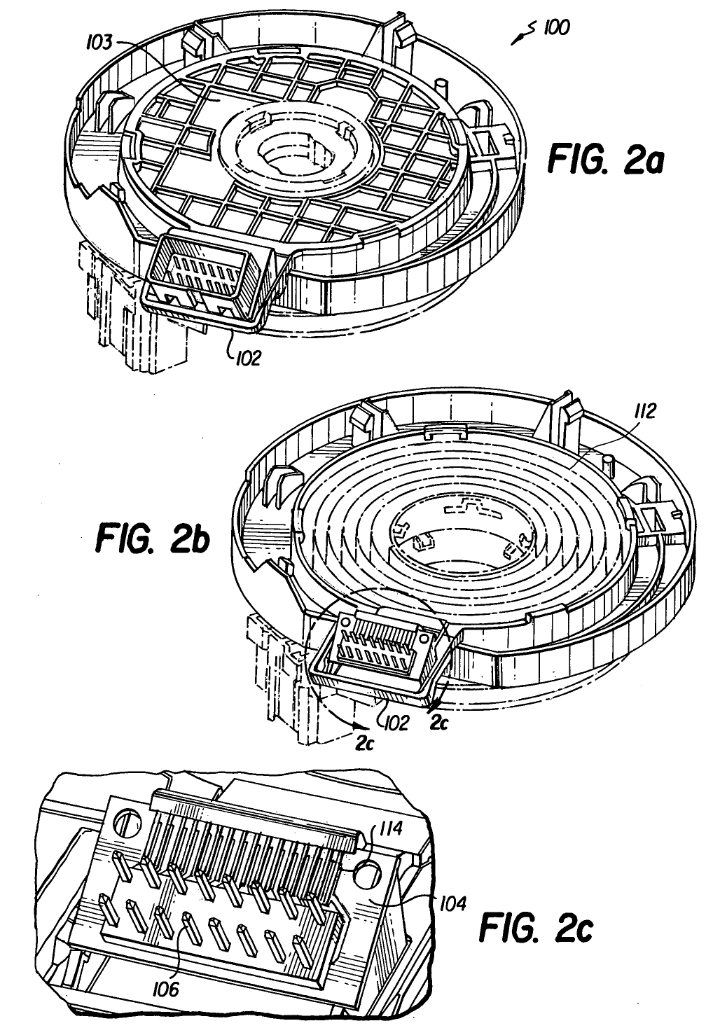

The circuit board 104 is shown in greater detail in FIGS. 3-5. The circuit board 104 has two rows of contacts 106 which connect to metal conductors 108 and end in solder pads 110. The solder pads 110 allow for much closer spacing as compared to the metal leads 22 of the prior art because they do not need to meet the spacing demands of the stamping process for the metal lead 22. More specifically, because the solder pads 110 can simply be laid onto the circuit board 104, the spacing requirements for stamping metal leads 22 a distance equal to their thickness to prevent deformation, are not present in the present application. The closer spacing of the solder pads 110 allow a flat cable to have more conductors, i.e, have a higher conductor density, than a flat cable produced using the welding process of the prior art. It should be noted that although FIGS. 3-5 show the contacts 106 of the circuit board 104 arranged in a double row of eight (8) contacts, the contacts 106 can be arranged in any pattern and remain within the scope of the present invention.

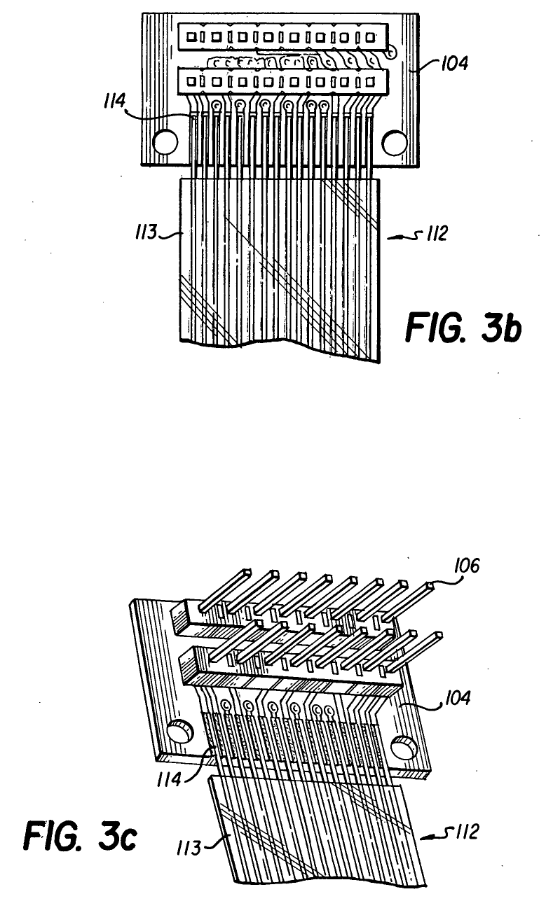

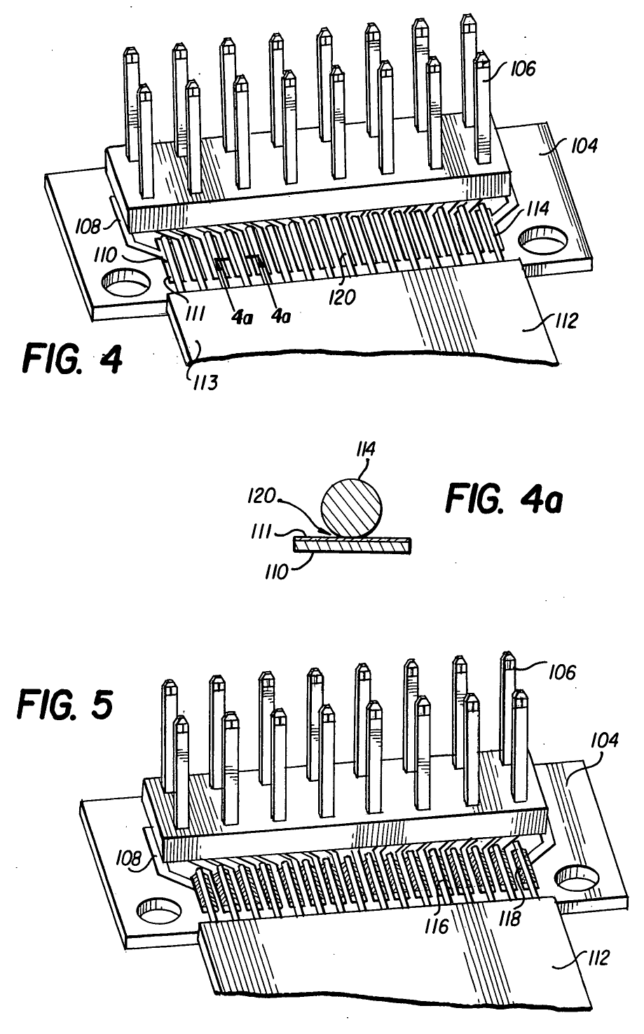

FIGS. 4 and 5 show the sixteen (16) conductor high density flat cable 112 having round conductors 114 soldered to the circuit board at the solder pads 110, with each conductor 114 being soldered to a single solder pad 110. The high density flat cable 112 includes a top and bottom insulating layer 113 made of plastic or similar material that cover the round conductors 114. FIGS. 3b and 3c show transparent insulating layers 113 so that the conductors 114 inside the flat cable 112 can be seen. The insulating layers 113 are bonded to each other using any non-adhesive means, an example of which is disclosed in U.S. Pat. No. 6,026,563 to Schilson, which is directed towards a method of sonically welding insulating layers around the conductors of a flat cable. The Schilson reference is hereby incorporated by reference in its entirety.

The conductors 114 of the high density cable 112 are round which facilitate the soldering of the conductor 114 to the solder pad 110. FIG. 4a shows an end view of the round conductor 114 along line 4-4 of FIG. 4. The round conductor 114 provide a groove 120 at the intersection of the round conductor 114 and the solder pad 110, which promotes wicking of solder material to fill the groove and form a stable solder joint.

An additional benefit of using round conductors is that the width of the solder pads 110 only needs to be as wide as the thickness of the round conductor 114, or only slightly wider. This is because of the grooves 120 at the intersection of the round conductor 114 and solder pad 110 provide the necessary space for the soldering material to bond the conductor 114 and the solder pad 110. In contrast, soldering a flat conductor would require larger solder pads 110, because considerable space, typically 12 the width of the flat conductor, is necessary adjacent the contact point between the flat conductor and solder pad for the solder material to accumulate.

Therefore, flat cables having round conductors that are soldered to the solder pads of a circuit board allow for a higher conductor density, increasing the amount of signal the flat cable is capable of carrying.

The soldering process used in the present invention may use any known soldering method. However, in the preferred embodiment, a hot bar soldering process is used. The hot bar soldering process uses a solder paste 111, which is a layer of soldering material formed over the solder pads 110 that melts and joins the round conductors 114 to the solder pads 110 during the soldering process. The solder paste 111 is shown in FIG. 4a. The conductors 114 are placed on the solder paste 111, after which a heat bar (not shown) is brought into close proximity to the solder paste 111, melting the solder paste 111 so that it flows around the conductors 114. The solder paste 111 is then allowed to cool and harden forming a stable electrical bond between the solder pads 110 and the conductors 114.

FIG. 5 shows the conductors 114 after being soldering to the solder pads 110. A solder fastening layer 116 is formed over the conductors 114 and fills the grooves 120 to join the conductors 114 to the solder pads 110.

Although preferred embodiments are specifically illustrated and described herein as being used with a clockspring, it should be appreciated that the structure and methods disclosed above may be used in situations not involving a clockspring, and many modifications and variations of the present invention are possible in light of the above teachings, without departing from the spirit or scope of the invention.

1. A flat cable circuit board assembly, comprising:
a flat cable having a plurality of round conductors therein and a circuit board having a plurality of solder pads; and
wherein the flat cable has at least one terminal end where the round conductors are exposed and soldered to the solder pads.

2. The flat cable circuit board assembly of claim 1, wherein
the flat cable is formed without the use of adhesives.

3. The flat cable circuit board assembly of claim 1, wherein
the flat cable is formed of a top and bottom insulating layer surrounding the round conductors, the top and bottom insulating layers being sonically bonded to one another to seal the round conductors.

4. The flat cable circuit board assembly of claim 1, wherein
the flat cable is used in a clockspring.

5. A clockspring for an use in an automobile comprising:
a housing holding a flat cable therein, the flat cable having round conductors and at least one end of the flat cable having its round conductors exposed and terminated by soldering to solder pads on a circuit board.

6. The clockspring of claim 5 wherein
the flat cable is formed without the use of adhesives.

7. The clockspring of claim 5 wherein
the flat cable is formed of a top and bottom insulating layer surrounding the round conductors, the top and bottom insulating layers being sonically bonded to one another to seal the round conductors.

8. A clockspring for use in a vehicle, comprising:
a clockspring housing having a circuit board adapted to be soldered to a flat electrical cable;
the circuit board including contacts connected to conductors placed onto the circuit board and solder pads connected to the conductors; and
wherein the solder pads are adapted to be soldered to conductors of the flat electrical cable.

9. The clockspring of claim 8, wherein
the solder pads include a layer of solder paste for soldering to the conductors of the flat electrical cable.

10-13 Cancelled

14. The flat cable circuit board assembly of claim 1, wherein
a housing holds the flat cable therein.

15. The flat cable circuit board assembly of claim 14, wherein
said housing is a clockspring housing; and
said circuit board is supported by said clockspring housing.

16. The flat cable circuit board assembly of claim 14, wherein
the solder pads include a layer of solder paste for soldering to the conductors of the flat cable.
